(19) United States
(12) Patent Application Publication
(10) Pub. No.: US 2007/0258172 A1
(43) Pub. Date: Nov. 8, 2007

(54) Analog ground-interference canceling device

(76) Inventors: Mark Thein, (US); Derek Immanuel Gaytan, (US)

Correspondence Address: Mark Francis Thein, 2500 Medallion Drive #112, Union City, CA, 94587, US

(21) Appl. No.: 11/416,446

(22) Filed: May 2, 2006

(51) Int. Cl. H02H 9/08

(52) U.S. Cl. 361/42

(57) ABSTRACT

An electronic circuit that is used to accept audio or video signals that are referenced to the electrical neutral because of the use of a two-wire power source and output the audio or video signals that are referenced to earth ground because of the use of a three-wire power source. The same electronic circuit is also used to accept audio or video signals that are referenced to earth ground because of the use of a three-wire power source and output the audio or video signals that are referenced to the electrical neutral because of the use of a two-wire power source. This electronic circuit can itself accept power from alternating current (AC) or direct current (DC) power sources for its operation.

### BACKGROUND

Ever since a person tried to connect audio or video signal cables from one device that has a two-wire power source to another device that has a three-wire power source (Example: VHS or DVD player to a desktop computer running a audio or video processing program) or from one device that has three-wire power source to another device that has a two-wire power source (Example: desktop computer, running a gaming or media player program, to stereo amplifier) and then experience interference as a result, the audio or video devices that have two-wire power sources cannot communicate with audio or video devices that have three-wire power sources directly unless the earth ground and the electrical-neutral are connected somewhere in the system.

To solve this problem the audio or video signals have to change their signal returns to or from the electrical-neutral to or from earth ground. One method like in U.S. Pat. No. 4,536,618 is to use an isolation transformer to couple the audio or video signals from one device to another or to isolate the power to one device and change its ground to the other device's ground. A similar method is in U.S. Pat. No. 5,841,467 and U.S. Pat. No. 5,606,734, where an RF carrier signal is used to carry the audio or video signal across a smaller transformer and then demodulated to recover the audio or video signal. Often these transformers have problems with size, bandwidth, or power capacity and the RF carrier signal can introduce noise, distortions or interferences of its own. Still another method is in U.S. Pat. No. 5,574,749 where an RF carrier signal is used to chop the audio or video signal and couple the result through capacitors and then detected and filtered to recover the audio or video signal. The same problems of noise, distortions or interferences of the RF carrier can still appear. Another approach is to use operational amplifiers like in U.S. Pat. No. 4,571,554 but only a single output is needed for each audio or video signal and the operational amplifiers may not be able to pass video signals unless they have the frequency bandwidth to do so.

### SUMMARY

The present invention provides an alternative solution to the problem by taking the audio or video signals, creating signals from them with opposite polarities using the same ground, electrical-neutral or earth ground, and sending both to an amplifier, connected to the other ground, that subtracts the opposite polarity from the original signal, creating a signal that is now referenced to the other ground and the noise and interference from the original ground is canceled out.

The present invention consists of a single signal driver and a single signal receiver coupled together to form a single signal path. The present invention then can consist of a single path or as many paths as needed to process signals that are going to or from electrical-neutral to or from earth ground. The present invention can be powered by an isolated alternating-current (AC) source or an isolated direct-current (DC) source.

### DRAWING DESCRIPTIONS

FIG. 1 is a gate-level schematic of the driver and receiver parts of the present invention.

FIG. 2 is a gate-level schematic of the power supply that will provide power to the present invention.

FIG. 3 is a block diagram that shows how the present invention is used for mono audio, stereo audio and video applications.

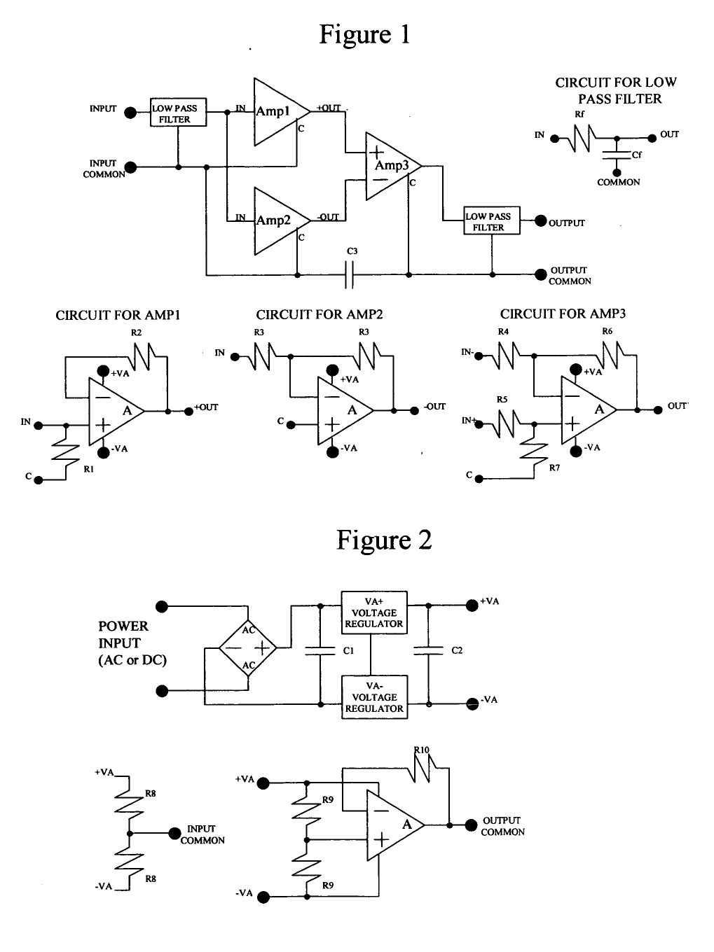

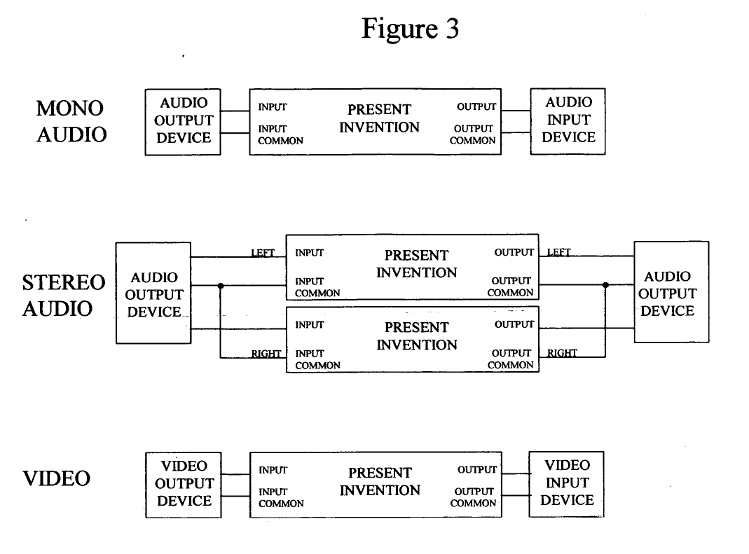

### DETAILED DESCRIPTIONS

The drawings show how the components that make up the present invention are connected together. The resistor components are labeled with an “R” followed by a number, the capacitor components are labeled with an “C” followed by a number and amplifier circuits are labeled with the word “Amp” followed by a number with the amplifier components labeled with an “A”.

For the power supply section the diode bridge can be a single component or four diode components connected together to function as the single component. The voltage regulators can consist of single components with a fixed output voltage or consist of single components with the output voltage set by two resistor components or consist of resistor, capacitor, diode, transistor and/or amplifier components connected together to function as the single components. The voltage regulators can be the type that operates in linear mode or the type that operates in switch mode, where the output voltage is determined by the duty cycle of switching between the input voltage and ground. The values of +VA and −VA can have any value between the minimum voltage that allows proper operation of the present invention to the maximum voltage the amplifier components can handle safely. The Amplifier that is driving the output common forces the output common to be always centered between +VA and −VA.

For the preferred embodiment of the present invention all the resistor components labeled “R1”, “R2”, “R3”, “R4”, “R5”, “R6”, “R7”, “R8”, “R9” and “R10” in the drawings have the same resistance value, which can be between 10,000 and 100,000 ohms. The amplifier components labeled “A” can be any operational amplifier that can meet the requirements of the signals being processed. Capacitor components “C1” and “C2” in the drawing can be any type capacitor with the proper values to make the voltage regulators operate properly. Capacitor component “C3” in the drawing can have a capacitance value between 100 picofarads to 0.1 microfarads to minimize noise transfer. The low-pass filters eliminate noise and other undesired signals that have frequencies above the desired bandwidth of the signals to be passed with the desired bandwidth determined by the combination of Rf and Cf that satisfies the equation Bandwidth=1/(2*3.14159*Rf*Cf) with Rf in ohms and Cf in farads.

The operation of the present invention with the preferred embodiment starts with the input of the present invention connected to an audio or video output device that can have its circuit common connected to the electrical neutral or earth ground. The output of the present invention is connected to an audio or video input device that has its circuit common connected to the electrical neutral or earth ground. The greatest benefit the present invention will provide will be when the output and input devices are in the situation where one device is connected to electrical neutral and the other device is connected to earth ground and there is no connection between the electrical neutral and earth ground. As a result there is residual AC voltage between the electrical neutral and the earth ground that will cause interference in the audio or video signals if the output device is directly connected to the input device. The present invention almost completely eliminates the interference by having its Amp1 pass the input signal as it is received and outputs it to the IN+ input on its Amp3. At the same time the present invention has its Amp2 create a signal that is opposite in polarity to the input signal and outputs it to the IN− input on its Amp3. The interference will appear on both inputs of Amp3 but will have the same polarity. Then Amp3 does an analog subtraction of the two input signals, resulting in the signal being passed becoming doubled (+Vin−−Vin or +Vin+Vin or 2×Vin) in amplitude and the interference being canceled out (Vint−Vint or 0V). Then Amp3 outputs the signal to the audio or video input device without passing along the interference.

If there is a desire to have the output signal the same amplitude as the input signal an alternative embodiment of the present invention can have R6 and R7 with a resistance value that is half the resistance value of R4 and R5. The interference canceling ability will not be affected.

If there is a desire to have the value of R5 be different from the value of R4 then the value of R7 must have the value of the value of R5 multiplied by the value of R6 divided by value of R4 in order to not affect the interference canceling ability.

If there is a desire to have the interference canceling property improved beyond what fixed-value resistors can provide an alternative embodiment of the present invention can have its R3 replaced with a slightly smaller value resistor and a potentiometer or rheostat in series, making the interference canceling property adjustable for maximum ability.

If the input bias current is not an issue due to the use of operational amplifiers with JFET inputs or CMOS construction an alternative embodiment of the present invention can replace R2 and R10 with a wire or direct connection.

For operation with more than one signal path from the output device to the input device the present invention can have embodiments that can consist of duplicating the circuitry of one signal path as many times as needed by the total number of signal paths without regard to the direction of the signal paths since the interference canceling property can operate in either direction.

For operation in environments where voltage spikes or dangerous voltages are present the low-pass filters can be equipped with voltage limiting or clamping devices to prevent damage to the circuitry of the present invention.

For operation in environments where electronic conditions are extra noisy the low-pass filters can consist of a single component or combination of passive and active electronic components.

An alternative embodiment is possible where Amp1 and Amp2 are replaced with wires for a direct connection to Amp3 without affecting the interference canceling property of the present invention.

What is claimed is:

1. An electronic circuit that is used to accept audio or video signals that are referenced to the electrical neutral because of the use of a two-wire power source and output the audio or video signals that are referenced to earth ground because of the use of a three-wire power source.

2. The device of claim 1, wherein the electronic circuit can also accept audio or video signals that are referenced to earth ground because of the use of a three-wire power source and output the audio or video signals that are referenced to the electrical-neutral because of the use of a two-wire power source.

3. The device of claim 1, wherein the circuitry in the device can be duplicated as many times as needed to provide paths for audio or video signals to be converted to or from electrical-neutral reference to or from earth-ground reference with the paths being in the same direction or in opposite directions.

4. The device of claim 1, wherein the circuitry can be stand alone or be part of a larger electronic circuit or system.
